(19) United States
(12) Patent Application Publication
(10) Pub. No.: US 2026/0143073 A1
(43) Pub. Date: May 21, 2026

(54) METHODS AND SYSTEMS FOR SCANNING MULTIPLE PAGES AT A MULTI-FUNCTION DEVICE

(71) Applicant: Xerox Corporation, Norwalk, CT (US)

(72) Inventors: Shoban Kumar Jayaraj Devadoss, Chennai (IN); Jeffrey A. Chester, Rochester, NY (US); Pandiarajan Subramanian, Chennai (IN)

(21) Appl. No.: 18/951,287

(22) Filed: Nov. 18, 2024

(51) Int. Cl. H04N 1/00; H04N 1/04

(52) U.S. Cl. CPC H04N 1/00742; H04N 1/04; H04N 2201/0094

(57) ABSTRACT

The disclosure discloses methods and systems for scanning multiple pages. The methods and systems can be implemented at a device such as a scanner, multi-function device, a mobile device, or an app running on the mobile device. The method receives the front side of the multiple pages to be scanned. In a first scan session, the front sides of the multiple pages scanned. Then, the back sides of the multiple pages are placed for scanning. In a second scan session, the back sides of the multiple pages are scanned. Based on an overlap and non-overlap area of the multiple pages scanned in the first scan session and the second scan session, the back side of a scanned page with the corresponding front side of that scanned page is associated. Based on the association, the scanned pages are arranged such that all scanned pages are in correct order in a scanned output such as PDF.

### TECHNICAL FIELD

The present disclosure relates to the field of scanning. More specifically, the disclosure relates to methods and systems for allowing users to easily perform multiple pages scanning at the same time and/or sequence these multiple pages accordingly.

There is a continuous need for users to scan documents such as ID cards, address proofs, passport etc., from both sides for various purposes. For example, sometimes, the user requires submitting documents in bank for loan, sometimes, he may need to submit documents in an office and so on. They can scan the documents using a mobile device, or a scanner. In case of a dual-side document, the user needs to scan each page one by one and flips each page till scanning is completed. For example, if a user requires to scan a 4-page document, then 4 times scanning as well as scan action is initiated and further 4 times physical action such as flipping the pages is performed by the user. In such methods, the number of scan actions increases with the number of pages, which further increases the effort of the user, and the overall process becomes time consuming. Several solutions are available in the market, but they don't allow users to do multiple pages scanning in one go. Additionally, there are challenges in sequencing the pages when dual-side pages are scanned this way and there are chances that the scanned pages may not be ordered correctly. For example, a scanned back side may not be correctly identified or associated with its front side. Thus, there is a need for improvised methods and systems that allow users to scan multiple pages at the same time, perform correct association and ease the overall process and experience for the user.

### SUMMARY

According to aspects illustrated herein, a method for scanning multiple pages is disclosed. The method includes receiving front side of each of the multiple pages to be scanned on a platen. A first scan session is initiated to scan the front side of each of the multiple pages placed on the platen. Then, back side of each of the multiple pages to be scanned on the platen are received. Similarly, a second scan session is initiated to scan the back side of each of the multiple pages placed on the platen. Then, for each of the scanned pages, the back side of a scanned page is associated with the corresponding front side of that scanned page, based on an overlap area and a non-overlap area of the multiple pages scanned in the first scan session and the second scan session. Based on the association, the scanned pages are arranged such that all scanned pages are in correct order in a scanned output. The scanned output can be further shared with any other user or stored for various purposes.

According to aspects illustrated herein, a multi-function device for scanning multiple pages is disclosed. The multi-function device includes a platen, a scanner, and a controller. The platen receives front side of each of the multiple pages to be scanned, and further receives back side of each of the multiple pages to be scanned. The scanner initiates a first scan session to scan the front side of each of the multiple pages placed on the platen and further initiates a second scan session to scan the back side of each of the multiple pages placed on the platen. The controller further associates a back side of a scanned page with the corresponding front side of that scanned page, based on an overlap area and a non-overlap area of the pages scanned in the first scan session and the second scan session, and this is done for each scanned page. The controller arranges the scanned pages such that all scanned pages are in correct order in a scanned output, based on the association. The correct order indicates that scanned back side is correctly associated with its front side.

According to additional aspects illustrated herein, a method for scanning multiple pages, is disclosed. The method includes receiving multiple pages to be scanned on a platen. Then, the multiple pages placed on the platen are scanned. Thereafter, a correct order of the multiple pages is identified for association, based on their placement location on the platen. Based on the identification, the scanned pages are arranged such that all scanned pages are in correct order in a scanned output.

According to furthermore aspects, a computer program product running on a multi-function device for scanning multiple pages is disclosed. The computer program product works in tandem with one or more components of the multi-function device and is configured for. in response to the multi-function device receiving scanned front sides of multiple pages, wherein the front sides of the multiple pages are scanned in a first scan session, and receiving scanned back sides of the multiple pages, wherein the back sides of the multiple pages are scanned in a second scan session; associating the back side of a scanned page with the corresponding front side of that scanned page, based on an overlap area and a non-overlap area of the multiple pages scanned in the first scan session and the second scan session. Based on the association, computer program product causes a controller to arrange the scanned pages such that all scanned pages are in correct order in a scanned output.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIGS. 1A and 1B show exemplary environments in which various embodiments of the present disclosure can be practiced.

FIG. 2A is a block diagram illustrating various components of a multi-function device, in accordance with an embodiment of the present disclosure.

FIG. 2B is a block diagram illustrating various components of a mobile device, in accordance with an embodiment of the present disclosure.

FIGS. 3A-3E are exemplary snapshots according to implementation of the present disclosure.

FIG. 4 is an overall method for scanning multiple pages and sequencing of the multiple pages based on their locations.

FIG. 5 is an exemplary method flowchart for scanning dual-side multiple pages and arranging them in a correct order.

FIG. 6 is an exemplary method flowchart for scanning single-side multiple pages and arranging them in correct order.

FIG. 7 is a method flowchart for capturing multiple pages according to the present disclosure.

### DETAILED DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “multi-function device” is a single device that performs one or more functions such as, but not limited to, printing, scanning, copying, imaging, or the like. The multi-function device may include software, hardware, firmware, or a combination thereof. In the context of the current disclosure, the multi-function device allows a user to easily scan multiple pages at the same time such that the number of scans and/or physical operations by the user are minimized. The multi-function device scans multiple pages as well as associates the scanned multiple pages in a correct order. For example, the multi-function device arranges the scanned pages in a correct order/sequence such that the back side of a scanned page is identified correctly and is further associated with the corresponding front side of that scanned page.

The term “document” refers to a document submitted for scanning and the document is in physical form such as printed on paper. The term “scanned document” and “scanned data” refers to an output generated upon completion of scanning activity and partial completion of the scanning activity, respectively. The scanned document and the scanned data are in virtual form or digital form. The term “scanned data” refers to raw scanned images/output generated upon scanning, where no image processing techniques are implemented. The scanned data refers to intermediate scanned images. The term “scanned document” refers to an output generated upon completion of the scan activity. The scanned document is referred to as a scanned output.

The term “multiple pages” refers to pages of a single document submitted for scanning. In some cases, the multiple pages may represent individual documents. The multiple pages include content in the form of text, images, graphics, or a combination thereof.

The term “dual-side” indicates content on both sides of a page, such as front side and back side of the page/document.

The term “single-side” indicates content on one side of the page, for example, front side.

The term “user” includes any user who submits multiple pages of a document for scanning. The user can be an admin user, can be an owner of the document or can be any other user who scans the multiple pages on the behalf of a different user, without deviating from the scope of the disclosure.

The term “location” refers to a location where the multiple pages are placed on a platform for scanning. The location can be determined/obtained based on coordinate information such as x, y coordinate.

The term “arranging” refers to sequencing the pages in a correct order. The arrangement of the pages may be based on page numbers or based on how the pages are placed at the time of scanning. The term “arranging” includes sequencing, ordering, associating, or other phrases that put the multiple pages correctly.

The term “correct order” refers to an order where one side of scanned page is correctly associated with its other side. For example, the back side of a scanned page is correctly associated with its front side or front side of a scanned page is correctly associated with its back side.

The term “intersection” includes overlap between two scanned pages. The intersection can be checked based on boundaries of the two scanned pages. In another example, the intersection can be checked based on the presence of the content on both sides of the scanned pages. The higher the intersection, higher are the chances of a scanned page to be back-side or front-side of each other.

The term “union” refers to include a total area covered by two scanned pages. The union can be checked based on the boundaries of the two scanned pages. In another example, the union can be checked based on the presence of the content on both scanned pages of the document.

The term “first scan session” refers to a scanning process initiated by a multifunction device to scan front sides of the multiple pages. While the term “second scan session” refers to a scanning process initiated by a multifunction device to scan back sides of the multiple pages. The scan sessions can be initiated based on an input from the user. The first scan session and the second session are just exemplary in nature, there can be more scan sessions such as third scan session, fourth scan session and so on. The number of scan sessions are based on the total number of pages in the document or the total number of pages to be scanned.

The term “mobile device” includes any electronic computing device that has image capturing functionalities. Various examples include, but are not limited to, a mobile device, a tablet, a Personal Digital Assistant (PDA), a smart-phone or any other device capable of data communication and/or image capturing features. In context of the current disclosure, the mobile device captures images of multiple pages and arranges the captured images in a correct order. In some implementations, the mobile device can have an app for capturing images of multiple pages and arranges the captured images in a correct order. The app refers to include any app or application that may be a web-based app or mobile app that can be downloaded on any device such as a mobile device.

The term “platform” refers to a platform, where the multiple pages can be placed for scanning or image capturing. For example, in the case of a multi-function device, the platform can be a platen. In the case of a mobile device, the platform can be a table, where multiple pages can be placed/arranged for capturing images.

The term “first image capturing session” refers to a session initiated to capture front side images of the multiple pages. While the term “second image capturing session” refers to a session initiated to capture back side images of the multiple pages.

The term “controller” refers to components of a computing device that include a computer processor and a non-transitory computer-readable medium (i.e., a memory). The processor and memory may be stored in a single device or multiple devices. In addition, a controller may be made up of a single processor device and a single memory device, or a controller may be made up of multiple processor devices and/or memory devices, some of which may be distributed and accessed via one or more communication networks.

When used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

The disclosure is discussed with respect to two implementations, one with respect to multi-function devices and second with respect to mobile devices. Accordingly, some defined terms may be used as-is and some may vary slightly. For example, the first scan session can be called as a first image capturing session in the case of mobile device. Similarly, the second scan session can be called as a second image capturing session in the case of mobile device. The scanned output is called the final output.

### Overview

The present disclosure discloses methods and systems for allowing users to easily scan multiple pages and sequence those multiple pages such that they are arranged in a correct order/associated correctly. The methods and systems minimize the number of scans and/or images capturing actions such as photo clicks that the user needs to perform while scanning the multiple pages. The multiple pages can be dual-side or can be single-side i.e., content on both sides of the pages or content on single side, respectively. The user places multiple pages, for example, front side on a device and flips the same. The odd numbered batches represent the front side, and the even numbered batches represent the back side of those pages. At the time of arranging, the even numbered scanned pages representing the back side of the pages are automatically inserted after the corresponding front side. This way, the pages are sequenced correctly, and a scanned output is generated.

### Example Environments

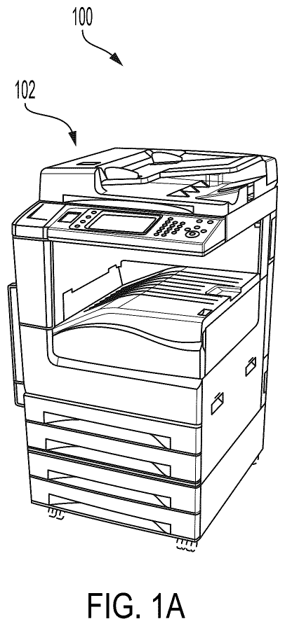

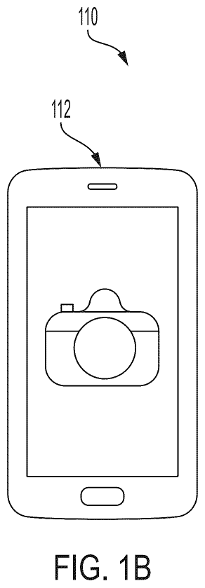

FIGS. 1A and 1B show exemplary environments 100, 110 in which various embodiments of the disclosure can be practiced. For example, the environment 100 includes a multi-function device 102 using which the present disclosure can be implemented, while the environment 110 includes a mobile device 112 using which the present disclosure can be implemented. The multi-function device 102 is a device that provides one or more functionalities such as printing, scanning, imaging, copying, and so on. The multi-function device 102 as shown is just one example but the environment 100 may include a scanner, or any device with scanning functionalities. In context of the present disclosure, the multi-function device 102 incorporates a new functionality for scanning. The new functionality scans multiple pages such that the multiple pages are scanned in minimum number of scans and the multi-function device 102 further arranges these multiple pages in a correct order.

In an implementation, a user places two or more pages on a platform such as a platen. In one example scenario, the pages are dual side and may belong to a single document. The user places the multiple pages such that front side of these pages is placed on the platen for scanning. The user presses a scan button or scan function of the multi-function device 102. Based on the input from the user, and the multi-function device 102 initiates a first scan, referred to as a first scan session. The multi-function device 102 scans and automatically stores scanned front sides of these multiple pages. The multi-function device 102 detects that there are multiple pages and stores them for later retrieval and/or use. The user then flips all pages and puts the back side of these multiple pages on the platen. The multi-function device 102 initiates a second scan, referred to as a second scan session. The multi-function device 102 scans and automatically stores scanned back sides of the multiple pages. The multi-function device 102 recognizes that the odd numbered pages/batches represent the front side of the pages, and the even numbered pages/batches represent back side of the pages. The odd numbered pages include pages numbered as 1, 3, 5 and so on, while the even numbered pages include pages numbered as 2, 4, 6 and so on. The odd numbered batches include pages placed together in the first scan session, third scan session, etc. and the even numbered batches include pages placed together for scanning in the second scan session, fourth scan session, etc. The multi-function device 102 automatically inserts these even numbered scanned pages representing back sides of the pages after the corresponding front side. This way, the multi-function device 102 sequences the scanned pages correctly. For example, the multi-function device 102 considers scan 1—page 1, scan 2—page 1, scan 1—page 2, scan 2—page 2. To this end, the multi-function device 102 determines an overlap and non-overlap area between the multiple pages scanned in the first scan session and the second scan session to identify and associate the back side of a scanned page with its corresponding front side of that scanned page. This is done for all scanned pages. This way, the multi-function device 102 identifies and associates the correct side of a scanned page with each other. In some implementations, the multi-function device 102 orders the pages based on the placement location of these pages in the first and second scan sessions on the platen. The multi-function device 102 orders the scanned pages such that the resulting scanned document has the scanned pages arranged in a correct sequence.

Although FIG. 1A is discussed, where the multiple pages are a part of a single document, but the multiple pages may represent individual documents. In further implementations, the multiple pages may have a single side, where the multiple pages may represent a single document or may be individual documents.

Similar to the multi-function device 102, the disclosure can be implemented using other devices such as mobile device 112 of FIG. 1B. In such cases, the user places multiple pages on a table such that images of the front side of the pages are captured. The user initiates a first session, referred to as a first image capturing session. The mobile device 112 includes an image capturing module 115 for scanning/capturing images of these multiple pages and automatically stores captured front side images of these multiple pages. The user flips the multiple pages and puts the back side of the multiple pages on the table and then initiates a second session, referred to as a second image capturing session. The image capturing module 115 captures images of the back side of these pages and automatically stores scanned back side images of these multiple pages. Based on an overlap and non-overlap area of the multiple pages captured in the first image capturing session and the second image capturing session, the mobile device 112 orders the pages such that the resulting final output has pages in a correct order. For example, the mobile device 112 arranges these multiple captured images such that back side images of these pages are associated with the corresponding front side images of those pages. This way, the scanned images are associated correctly.

### Example System

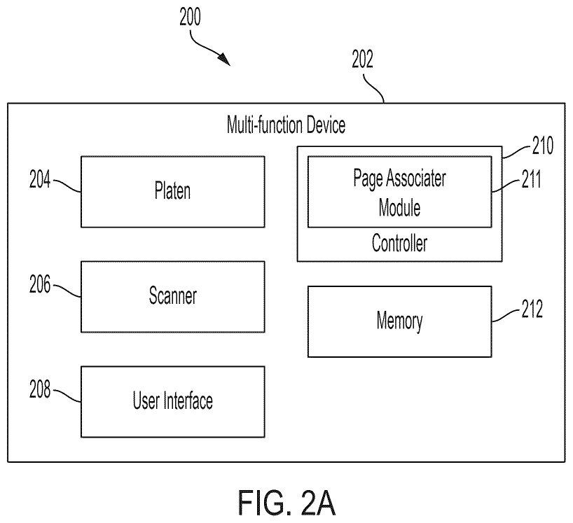

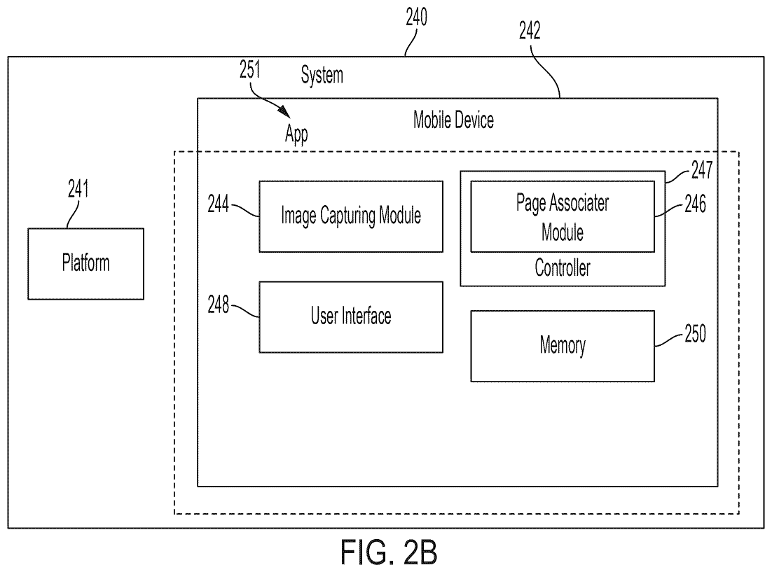

FIG. 2A is a block diagram 200 illustrating various components of a multi-function device 202 for implementing the current disclosure. As shown, the multi-function device 202 includes a platen 204, a scanner 206, a user interface 208, a controller 210 including a page associating module 211 and a memory 212. The components 202-210, 211-212 are connected to each other via a conventional bus or a later developed protocol. Further, the components 202-210, 211-212 communicate with each other for performing various functions of the present disclosure. The multi-function device 202 may further include additional component(s) as required to implement the present disclosure. For example, the multi-function device 202 may include a print engine, a copy engine, or the like.

The implementation begins when a user wishes to scan multiple pages. Each of the multiple pages have a front side and a back side. In one example scenario, all pages may have a front side and a back side. In another example scenario, some pages may have a front side, and some may not have back side, for example, last page, meaning that the last page may not have content. The multiple pages may be a part of a single document, or these multiple pages may represent individual documents. For the sake of discussion, FIG. 2A is discussed with respect to a scenario, where these multiple pages are a part of a single document, and the document is a dual-side document.

In implementation, a user places multiple pages of a document on the platen 204. The platen 204 receives the multiple pages of the document. The user places the multiple pages on the platen 204 in a matrix layout format. However, the user can place the multiple pages in other known ways or later developed suitable ways. The user can place any number of multiple pages on the platen 204. For example, the user can place 2 pages at a time. In another example, the user can place 3 pages, 4 pages, 6 pages and 8 pages at a time on the platen 204 for scanning. The number of pages that can be placed on the platen 204 may depend on the size of platen 204. Alternatively, the number of pages that can be placed on the platen 204 may depend on the size of the page.

Specifically, the user places the front side of the multiple pages on the platen 204. Once the user places the multiple pages on the platen 204, the user provides an input to initiate a scan operation, referred to as a first scan session. The input can be provided by pressing a physical scan button provided on the multi-function device 202. Alternatively, the scan operation can be initiated by the user using a scan function given on the user interface 208 of the multi-function device 202. The scanner 206 initiates the scan operation, scans these multiple pages placed on the platen 204 and stores these scanned multiple pages in the memory 212 for later retrieval and/or use. The multiple pages represent the front side of the multiple pages of the document. For example, the scanner 206 captures images of the multiple pages of the document. Here, the scanner 206 scans the front side of the multiple pages and stores front side scanned pages in the memory 212 for later retrieval and/or use. The user then flips the multiple pages and further places back side of these multiple pages on the platen 204. The user further provides input to initiate the scan operation and this scan operation is referred to as a second scan session. The scanner 206 scans the multiple pages of the document and stores these scanned pages in the memory 212 for later retrieval and/or use. Here, the scanner 206 scans the back side of the multiple pages and stores back side scanned pages in the memory 212 for later retrieval and/or use. This way, scanning of the multiple pages of the document is completed. While storing, the front side scanned pages are tagged with a keyword such as scan #1 for easy identification and processing at later stages; this indicates these are front side scanned pages. While storing, the back side scanned pages are tagged with a keyword such as scan #2 for easy identification and processing at later stages; this indicates these are back side scanned pages.

The scanner 206 sends the scanned images of the multiple pages taken in the first scan session and the second scan session to the controller 210. The controller 210 automatically detects that there are multiple scanned pages and then segments these multiple pages. The controller 210 segments each scanned page based on the boundary of these pages. The controller 210 detects the number of pages based on boundary/sheet detection algorithms and space detection methods. The controller 210 thereafter triggers the page associating module 211. The page associating module 211 receives the scanned pages of the document scanned in the first scan session and receives the scanned pages of the document scanned in the second scan session. The page associating module 211 recognizes that the scanned pages in the second scan session represent back sides and the scanned pages in the first scan session represent front sides of the scanned pages. The page associating module 211 further determines which scanned pages from the second scan session represent the back side of the pages scanned in the first scan session. In one example, the determination is performed based on an overlap and non-overlap area of the multiple pages scanned in the first scan session and the second scan session. To determine this, the page associating module 211 uses intersection over union (IoU) technique to determine which scanned pages from the second scan session represent back side of the pages scanned in the first scan session. The page associating module 211 calculates IoU for each page scanned in the second scan session against all pages scanned in the first scan session. The intersection provides an overlap between the scanned pages in the first scan session and the second scan session, whereas the union determines the non-overlap/total region between the scanned pages in the first scan session and the second scan session. The IoU provides page pair or page combination scores. The highest page score indicates high overlap between pages scanned in the first scan session and the second scan session, as a result, that page is the back side of a page scanned in the first scan session. Higher score (max of 1.0) indicates high overlap between the scanned page in the first scan session vs second scan session, which is likely be the back side of the first scanned page. The score can have a maximum value of 1.

A pre-defined equation for IoU calculation is provided below:

IoU=(area of the intersection of the 1st scan page vs 2nd scan page)/(area of the union of the 1st scan page vs 2nd scan page)

More details on the IoU calculation will be discussed below in other figures. The area of union and intersection is calculated based on the pixel coordinates of scanned page 1, for example and its back side i.e., scanned page 2. Intersection indicates the total number of pixels that fall in the intersection area and union represents the total number of pixels in the union area of scanned pages 1 and 2. This way, the page associating module 211 determines correct page combination i.e., which scanned page is back side of the corresponding front side.

Once the page combinations are identified, the page associating module 211 associates scanned pages in the first scan session with scanned pages from the second scan session. The page associating module 211 sends the association of scanned pages in the first scan session and the second scan session to the controller 210 for further processing. The controller 210 arranges the scanned pages such that back side of a scanned page is correctly associated/placed with a corresponding front side of that scanned page and the controller 210 arranges all the scanned pages in the correct order. The controller 210 finally creates a scanned document/output by implementing one or more image processing techniques and finally creates a scanned output/document. The scanned document can be shared with other users. The scanned document can be stored in the memory 212 or can be stored over a cloud location or the like. In other example, the scanned document can be sent via email. This way, the multi-function device 202 allows scanning of the multiple pages as well as performs correct sequencing/association of pages such that they are in the correct order.

The user interface 208 displays various messages or notifications to the user. For example, the user interface 208 displays a notification to the user when the first scan session is completed—“please flip your pages”. Another message may be—“please put back side of the pages”. The user interface 208 also allows the user to provide an input such as user details for logging in to the multi-function device 202 or other information for implementing the current disclosure. The user interface 208 may ask the user to input which page is a back side of a particular page. In such cases, the user can input the page number manually via the user interface 208. Although the user interface 208 as shown in FIG. 2A is a part of the multi-function device 202, but the user interface 208 can be an external display or device that can be connected to the multi-function device 202.

The memory 212 stores various information and details required for implementing the current disclosure. For example, the memory 212 stores pages scanned in the first scan session and the second scan session and so on. The memory 212 stores association of each scanned page with each other. The memory 212 can further store scanned pages, scanned data, pre-defined equation/formula, or the like. In another example, the memory 212 stores user details such as username, password, credentials, scan preferences and so on. The controller 210 or other modules can access the memory 212 to retrieve the relevant information as required.

The page associating module 211 is shown to determine association of each scanned page with each other based on IoU calculation and other approaches as mentioned. But the functionality of the page associating module 211 can be directly incorporated in the controller 210 of the multi-function device 202.

In an example implementation, upon IoU calculation, the page combinations that have the highest score in each subsequent scans can be stored in separate files thereby allowing the user to perform parallel scan of multiple documents simultaneously. For example, if a user needs to scan a form having a fixed set of 10 pages and if there are multiple such forms, say, 4 forms, the user can scan these multiple forms in the minimum scans. In the existing solutions, the user needs to scan all the 40 pages one by one, and 40 scans are needed. According to the implementation of the disclosure, the user can place the first page of all 4 forms and perform scanning. Then, the user can flip the first pages of all the 4 forms and perform the next scan and continues till the last page of each form. This way, the user performs 40 flips, but the number of scans is reduced to 10. Therefore, the disclosure offers an easy, quick, and efficient way to perform scan of multiple pages.

Although FIG. 2A is discussed with respect to a scenario, where the multiple pages are a part of a single document but there can be scenarios when the multiple pages are individual dual-side documents. In such cases, the user can provide the input in the beginning indicating that these are individual documents. Accordingly, the controller 210 receives the input and processes the scanned pages accordingly. In such cases, the controller 210 considers the number of pages equal to the number of documents. The controller 210 passes this information to the page associating module 211. The page associating module 211 performs IoU of pages scanned in the second scan session with a single scanned page in the first scan session instead of all scanned pages in the first scan session. This way, the processing time is a bit reduced. The page associating module 211 performs IoU, identifies back side of the corresponding front side of the scanned page, associates the front side and back side of the scanned page and passes the associated pages to the controller 210. The controller 210 performs all image processing techniques to create a scanned document. In this case, multiple scanned documents are generated. For example, if two pages are submitted initially, then two scanned documents are created and so on.

There can be additional scenarios where the multiple pages can have a single side. In such cases, the user provides input while initiating a scanning workflow. The controller 210 receives the input and processes the scanned pages accordingly. The controller 210 passes the information to the page associating module 211. The page associating module 211 does not implement IoU technique to determine the page association/sequence. In such implementations, the page associating module 211 determines which scanned page is a front page and which scanned page represents a back side, based on the locations of the pages placed on the platen 204. The page associating module 211 sequences the pages based on their locations from left to right and/or from top to bottom. The controller 210 accordingly generates a scanned document. If these multiple pages are a part of single document, then a single scanned output is generated. But if these multiple pages are individual documents, then multiple scanned outputs are generated.

Similar to the multi-function device 202, the disclosure can be implemented using a mobile device such as 112 shown in FIG. 1B and more implementation details are discussed in FIG. 2B.

FIG. 2B shows a system 240 including a mobile device 242 and a platform 241. The platform 241 can be a table or any platform where the multiple pages can be placed for scanning/image capturing. The mobile device 242 includes an image capturing module 244 such as a camera, a controller 246 including a page associating module 247, a user interface 248 and a memory 250. Initially, the user places the multiple pages on the platform 241. One example of the platform can be a table where the multiple pages can be arranged. The user then captures the multiple pages using the image capturing module 244, for example, via, click picture option/button as known or later developed ways to capture the image. The user places front sides of the multiple pages on the platform 241 and initiates a first session such as a first image capturing session. In the first image capturing session, the image capturing module 244 captures an image of front side of each of the multiple pages placed on the platform 241. The user then flips the multiple pages and places back sides of the multiple pages on the platform 241 and initiates a second session such as a second image capturing session. In the second image capturing session, the image capturing module 244 captures an image of back side of each of the multiple pages placed on the platform 241. The captured front side images of the multiple pages and the back side images of those multiple are stored in the memory 250 for later retrieval and/or use. The captured front side images and the back side images are sent to the controller 246 for further processing. The controller 246 checks if the user wishes to perform a dual-side scanning or if the document has dual-side. Based on the user input, the controller 246 proceeds forward. Upon receiving, the controller 246 detects that there are multiple pages in the first session and the second session. The page associating module 247 identifies and associates back side images with corresponding front side images, based on an overlap and non-overlap area of the multiple pages captured in the first session and the second session. The page associating module 247 determines overlap and non-overlap areas between the multiple images captured in the first session and the second session. The overlap area is determined by finding an area of intersection of the multiple pages captured in the first session and the second session and the non-overlap area is determined by finding an area of union of the multiple pages captured in the first session and the second session. Based on the association, the controller 246 arranges the captured images such that all captured images are in correct order in a final output.

The click is referred to as a first image capturing session and next time when the user clicks again, it is referred to as second image capturing session.

The user interface 248 displays various messages or notifications to the user. For example, the user interface 248 displays a notification to the user when the first scan session is completed—“please flip your pages”. Another message may be—please put back side of the pages. The user interface 248 also allows the user to provide an input required for implementing the current disclosure. The user interface 248 may ask the user to input which page is a back side of a particular page. In such cases, the user can input the page number manually via the user interface 248.

The memory 250 stores various information and details required for implementing the current disclosure. For example, the memory 250 stores images captured in the first session and the second session and so on. The memory 250 stores association of each captured image with each other. The memory 250 can further store captured images, pre-defined equation/formula, or the like. In another example, the memory 250 stores user details such as username, password, credentials, scan preferences and so on.

The functionalities discussed above can be implemented using one or more modules such as 244, 246, 247, 248 and 250 but the functionalities can be incorporated and implemented in the form of an app such as 251. The app 251 can be a web-based app accessible via any browser as known or later developed browsers. The app 251 can be mobile app that can be downloaded on the mobile device 242. In the case of app, the app 251 captures the multiple pages, identifies, and associates all back side captured images with their respective front side images and generates a final output in a correct order.

### Example Flowcharts

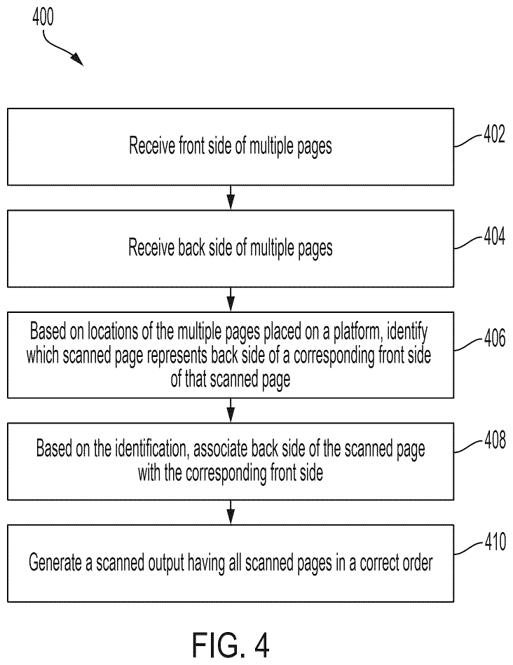

FIG. 4 is a flowchart showing a method for scanning multiple pages, according to implementation of the disclosure. The method 400 can be implemented at a device such as a multi-function device, a scanner, a mobile device, or any device with image capturing functionality. For example, the method 400 can be implemented at a multi-function device 102 of FIG. 1A or mobile device 112 of FIG. 1B or multi-function device 202 of FIG. 2A, or mobile device 242 of FIG. 2B.

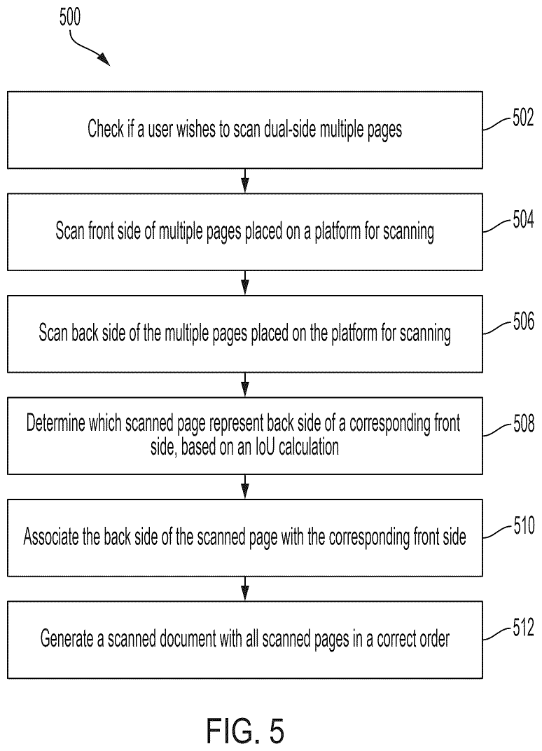

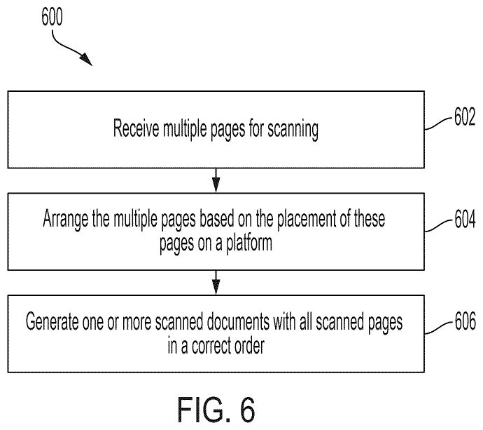

The method 400 begins when a user wishes to scan multiple pages. The multiple pages may be a part of single document or may be individual documents. The multiple pages may be dual-side or may be single-side. The user places multiple pages on a platform, specifically, places front side of the multiple pages on the platform and those multiple pages are received at the multi-function device, at 402. After placing the multiple pages, the user initiates scanning for scanning the multiple pages and this scan session is referred to as a first scan session. The scanned front side of the multiple pages are stored. The user places back side of the multiple pages on the platform. At 404, back side of the multiple pages are received at 404. The user again initiates another scanning session, and this scan session is referred to as a second scan session. The scanned back side of the multiple pages are stored. At 406, based on the placement location of the multiple pages on the platform, in the first scan session and the second scan session, it is identified which scanned page represents back side of a corresponding front side of that scanned page. The block 406 is performed for each scanned page. At 408, scanned back side is associated with the corresponding scanned front side based on the identification. At 410, a scanned output is generated finally such that all scanned pages are in correct order. In case the multiple pages belong to the same document, a single scanned document/output is generated. In case the multiple pages belong to individual documents, multiple scanned documents/outputs are generated. More details on dual-side multiple pages scanning and single-side multiple pages scanning will be discussed below in FIGS. 5 and 6.

FIG. 5 is a method flow chart for scanning dual-side multiple pages and arranging them in a correct order. The method 500 can be implemented at a device such as a multi-function device, a scanner, a mobile device, or any device with image capturing functionality. For example, the method 500 can be implemented at a multi-function device 102 of FIG. 1A or mobile device 112 of FIG. 1B or multi-function device 202 of FIG. 2A, or mobile device 242 of FIG. 2B.

The method 500 begins when a user wishes to scan dual-side (i.e., content on both sides of the pages) multiple pages. The dual-side multiple pages can be individual documents, or the dual side multiple pages may be a part of a single document. For simplicity, the method 500 is explained with respect to a single document but the method 500 can be implemented where the multiple pages correspond to multiple individual documents. The document is a multi-page dual-side document, where each page may have a front-side and a back side. In some examples, the last page of document may or may not have a back side, i.e., meaning that no content is present on the back side. For example, if the document is a 4-page document, then page 1 represents front side, page 2 represents back side of page 1, page 3 represents front side and page 4 represents back side of page 3. In another example, if the document is a 3-page document, then page 1 represents front side, page 2 represents back side of page 1, page 3 represents front side and page 4 is blank. The document can be of any size or can be of any type. For example, the document can be a book, an address proof, a mark sheet, a birth certificate, a passport, an office document, a bank document, an application form or the like. The document can be A4, A5, A7 or any type. Further, the document can include content in the form of text, image, graphics, or a combination thereof. Each page of the document may have page numbers associated with it. Otherwise, the page numbers can be automatically assigned/considered at the time of implementation.

In implementation, the user places multiple pages of a document on platform for scanning. It can be considered that the document is a 4-page document. It can be considered that the user first places front sides of the document/multiple pages and later places the back side of those pages. The user places multiple pages such that page 1 is placed and at some distance from the page 1, page 3 is placed. For example, the pages may be placed in a matrix layout. Here, page 1 and page 3 represent the front sides of the document. After placing the multiple pages, the user initiates a scanning workflow. In context of the current disclosure, the user initiates a multi-page scan workflow. Once the workflow is initiated, then it is checked with the user if pages to be scanned are dual-side or single-side, at 502. For example, a user interface is presented to the user with an option for dual-side scanning or single-side scanning. The user selects the dual-side scanning option, and the user provides an input to initiate scan operation. For example, the user presses a scan button/scan function on the multi-function device. The user first places the front sides of the multiple pages on the platen. The front side of each of the multiple pages to be scanned are received on the platform. The user then starts the scan activity and based on the user input, a first scan session is initiated. At 504, the front side of the multiple pages placed on the scanning platform are scanned in the first scan session. It is detected that there are multiple pages in the first scan session. Here, the image of the multiple pages is captured, wherein multiple pages captured in the image are cropped/segmented using one or more known or later developed methods. This way multiple scanned pages scanned in the first scan session are segregated from each other and each scanned page represents front side. The front side scanned pages are stored for later retrieval/use. Then, an instruction is provided to the user via the user interface to flip these multiple pages. This time, the back side of each of the multiple pages is received on the platform for scanning. The user flips and initiates a scan operation again. Based on the user input, a second scan session is initiated. At 506, the back sides of the multiple pages placed on the scanning platform are scanned. It is detected that there are multiple pages in the second scan session. Again, the image of the multiple pages is captured, where individual scanned pages are cropped/segmented using one or more known or later developed methods. This way, multiple scanned pages scanned in the second scan session are segregated from each other and each scanned page represents the back side. The back side scanned pages in the second scan session are stored for later retrieval/use. At 508, it is then determined which scanned pages represent back sides of the corresponding scanned front sides. Specifically, this includes identification and association of a back side of a scanned page with a corresponding front side of that scanned page, from the multiple scanned pages in the first scan session.

This is determined based on an overlap and non-overlap area of the multiple pages scanned in the first scan session and the second scan session. The overlap and non-overlap areas between the multiple pages scanned in the first scan session and the second scan session, are determined based on a pre-defined equation such as area of intersection/area of union. The overlap area is determined by finding an area of intersection between the multiple pages scanned in the first scan session and the second scan session, while the non-overlap area is determined by finding an area of union between the multiple pages scanned in the first scan session and the second scan session. Here, an area of intersection for each scanned page in the second scan session is calculated against all scanned pages in the first scan session.

To this end, coordinates of the platform are retrieved. The coordinates of the platform can be pre-stored in the memory. Further, coordinate of the multiple pages scanned in the first scan session i.e., page 1, page 3 is calculated. Similarly, coordinate of the multiple pages scanned in the second scan session i.e., page 2, page 4 is calculated. For example, x and y coordinate of all pages scanned in the first scan session and the second scan session is calculated. In some examples, the coordinate information can be obtained based on the location of these pages on the platform. The coordinate information of the platform is known, and based on the known information, coordinates of the scanned pages in the first scan session and the second scan session are obtained. Based on the coordinates, area for each scanned page in the first scan session and the second scan session is calculated.

Then, an area of intersection for scanned page 2 is calculated with scanned pages 1 and 3. Similarly, an area of intersection of scanned page 4 is calculated with scanned pages 1 and 3. Then, an area of union for scanned page 2 is calculated with scanned pages 1 and 3. Similarly, area of union of scanned page 4 is calculated with scanned pages 1 and 3. Finally, an area of intersection is divided with area of union. For scanned page 2, if IoU with page 1 is greater than IoU of scanned page 3, then scanned page 2 is considered as back side of the scanned page 1. In another example, if IoU of scanned page 2 with scanned page 3 is greater than IoU of scanned page 1, then scanned page 3 is considered as back side of the scanned page 1. In this case, scanned page 2 is considered as back side of scanned page 1. Alternatively, IoU can be compared with a pre-defined threshold and based on the comparison, it is determined if a scanned page is back side of a page scanned in scan session 1. If the IoU is within a pre-defined threshold, then that scanned page is determined as back side of the respective scanned front page. The pre-defined threshold can be any value that is defined by an administrator of the device or can be defined automatically by the device.

In some scenarios, the determination of which scanned pages represent back sides of the respective front pages is done based on center of scanned pages in the first scan session. Centre of all pages scanned in scan session 1 is matched with center of all pages scanned in scan session 2. In such implementations, the center of scanned page 1 is determined, similarly, center of scanned pages 2 and 4 is determined. Thereafter, distance of the scanned page 1 is seen with scanned pages 2 and 4. Based on the distance, it is estimated which scanned page is back side of scanned page 1. The lesser the distance, the more the chances of that scanned page as back side of scanned page 1. For example, if it is a 4-page document, then distance between center point of scanned page 1 and scanned page 2 is calculated. Similarly, distance between center point of scanned page 1 and scanned page 4 is calculated. Based on the distance calculation, it is determined that scanned page 2 is the back side of scanned page scanned in scan session 1, for example, scanned page 1. This implementation can be considered along with IoU calculation or independent of IoU in some implementations.

Once the back side of respective front side is determined for each scanned page, then at 510, association of back sides of a scanned page with their respective front sides is performed for each scanned page. Specifically, a back side of a scanned page is associated with a corresponding front side of that scanned page, from the multiple scanned pages in the first scan session. This way, correct sequencing of scanned pages is completed.

The method additionally includes associating the scanned back sides of the multiple pages with the corresponding scanned front sides of the multiple pages based on their location from left to right and/or from top to bottom. The method additionally includes identifying association of the pages scanned in the first scan session and the second scan session based on one or more methods as discussed below in detail.

At 512, scanned document as output is generated such that all scanned pages are arranged in a correct order/sequence. The scanned document can be stored, sent, or shared with other users based on the requirement. Here, arranging the scanned pages includes arranging the scanned pages such that all scanned back sides of the multiple pages are correctly arranged with their corresponding scanned front sides of the multiple pages.

### Scenario 1

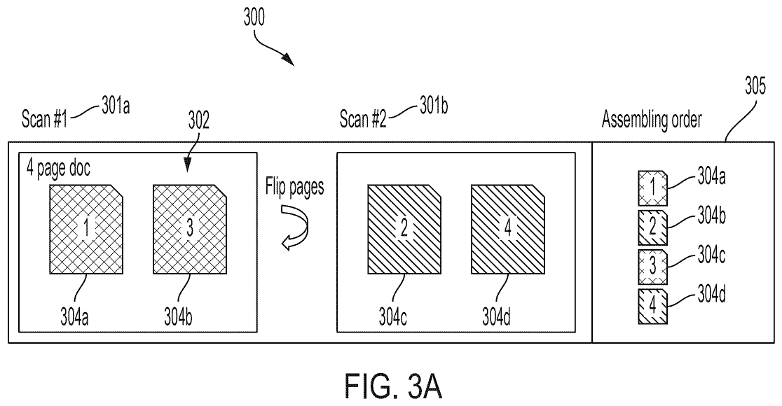

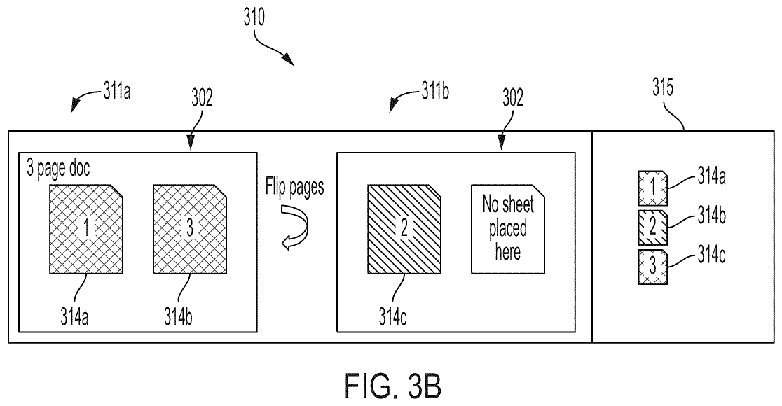

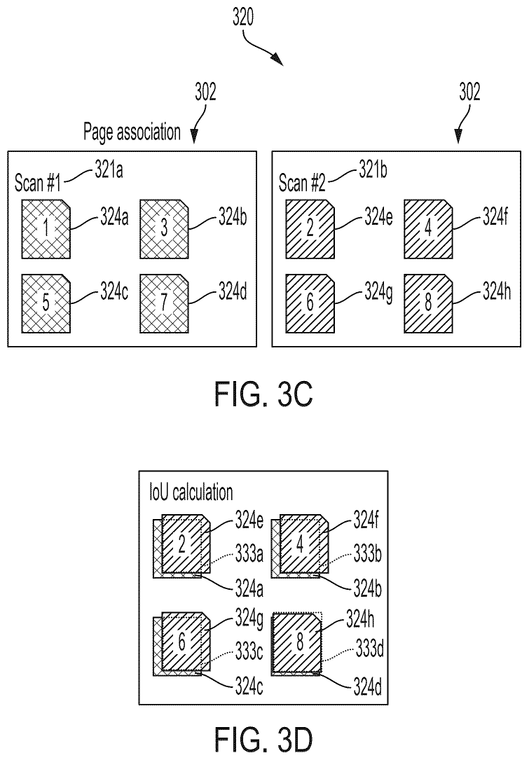

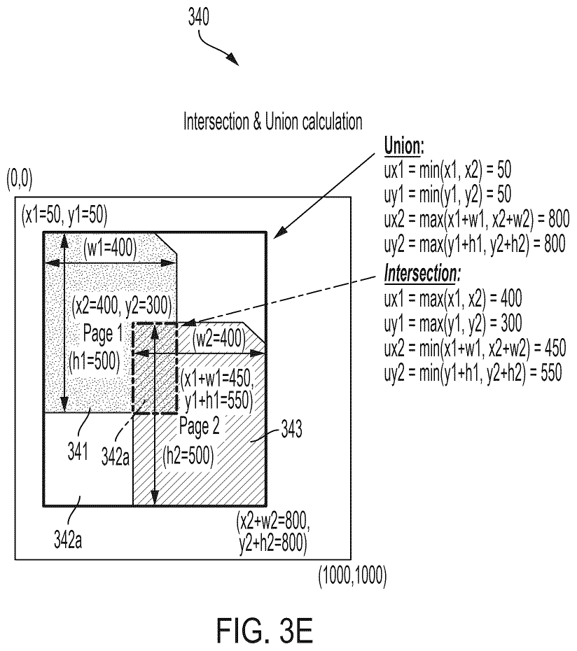

An example scenario is discussed for easy understanding. In this example scenario, a user wishes to scan a 4-page document such as document 300 as shown in FIG. 3A. The user separates all pages and puts pages 1 (marked as 304a) and page 3 (marked as 304b) on the platen 302 as shown in FIG. 3A. It is shown that page 1 (304a) and page 3 (304b) are put on the platen 302 at a certain distance from each other. A first scan session, marked as 301a, is initiated for scanning pages 1 and 3. Once that is done, the user flips the pages and places those pages i.e., page 2 (marked as 304c) and page 4 (marked as 304d) of the document on the platen 302 as can be clearly seen in the figure. Then, a second scan session, marked as 301b, is initiated for scanning pages 2 and 4. The implementation of the present disclosure requires only 2 scans for scanning 4-page document instead of 4 scans as in the existing solutions. Thereafter, IoU is calculated as discussed above. Based on the intersection over union calculation, page associations/sequences are determined and sequenced in the correct order as seen in FIG. 3A. Finally, a scanned output such as 305 is generated having scanned pages arranged in the correct order i.e., scanned page 304c (which is back side of the scanned page 304a) is placed after the scanned page 304a and similarly, scanned page 304d (which is back side of the scanned page 304b) is placed/inserted after the scanned page 304b.

### Scenario 2

Another example scenario is discussed for easy understanding. In this example scenario, a user wishes to scan a 3-page document such as document 310 of FIG. 3B. The user separates all pages and puts page 1 (marked as 314a) and page 3 (marked as 314b) on the platen 302 as shown in FIG. 3B. It is shown that pages 1 (marked as 314a) and page 3 (marked as 314b) are put on the platen 302 at a certain distance from each other. Then, a first scan session 1, marked as 311a, is initiated for scanning pages 1 and 3. Once that is done, the user flips the pages and places the pages such as page 2 (marked as 314c) on the platen 302. Then, a scan session 2, marked as 311b, is initiated for scanning page 2. The implementation of the present disclosure requires only 2 scans for scanning 3-page document instead of 3 scans as in the existing solutions. Thereafter, IoU is calculated as discussed above. Based on the intersection over union calculation, page associations are determined and sequenced in the correct order as seen in FIG. 3B. Finally, a scanned output such as 315 is generated having scanned pages arranged in the correct order i.e., scanned page 314c (which is back side of the scanned page 314a) is placed after the scanned page 314a and similarly, scanned page 314b is placed thereafter.

### Scenario 3

An additional example scenario is discussed, where an 8-page document such as document 320 is submitted for scanning as shown in FIG. 3C. The user first places page 1 (marked as 324a), page 3 (marked as 324b), page 5 (marked 324c), page 7 (marked as 324d) on the platen 302. Then, a first scan session, marked as 321a, is initiated for scanning pages 1, 3, 5 and 7. The user then flips the pages and now places page 2 (marked as 324e), page 4 (marked as 324f), page 6 (marked as 324g), and page 8 (marked as 324h) on the platen 302. Then, a second scan session, marked as 321b, is initiated for scanning pages 2, 4, 6 and 8. Thereafter, IoU is calculated as discussed above. IoU calculation involves intersection of pages scanned in the first scan session and the second session that is shown in snapshot 330 of FIG. 3D. As can be clearly seen, the marking 333a shows an intersection between scanned pages 2 and 1, the marking 333b shows an intersection between scanned pages 4 and 3, the marking 333c shows an intersection between scanned pages 6 and 5, and the marking 333d shows an intersection between scanned pages 8 and 7. Similarly, an area of union can be calculated and based on the IoU calculation, association of these scanned pages is performed and finally scanned pages are sequenced in a correct order.

It can be considered that boundary of page 1 is x1 (x coordinate), y1 (y coordinate), w1 (width), h1 (height), where x and y are the left top coordinates of the page in the entire scanned content. Similarly, page 2 has x2, y2, w2, h2. Now, boundary of page 1 is x1, y1, x1+w1, y1+h1. Similarly, the boundary of page 2 is x2, y2, x2+w2, y2+h2. The union is determined by the smallest and largest x and y coordinates. ux1=min (x1, x2), uy1 min (y1, y2), ux2=max (x1+w1, x2+w2) and uy2=max (y1+h1, y2+h2). So, the union area is (ux1, uy1) to (ux2, uy2). Intersection is ux1=max (x1, x2), uy1=max (y1, y2) and ux2=min (x1+w1, x2+w2) and uy2=min (y1+h1, y2+h2) considering that both the pages overlap. Similarly, union and intersections are calculated for each scanned page.

One such example is seen in a snapshot 340 of FIG. 3E, where two scanned pages such as 341 and 343 are included. In the example of FIG. 3E, areas of union and intersection are shown as 342a and 342b, respectively. Here, a boundary of scanned page 1 (marked as 341) is defined by x1=50, y1=50, w1=400, h1=500 where x and y are the left top coordinates of the scanned page in the entire scanned content. Similarly, scanned page 2 (marked as 343) has x2=400, y2=300, w2=400, h2=500. Now, boundary of scanned page 1 (marked as 341) is x1, y1, x1+w1, y1+h1. Similarly, boundary of scanned page 2 is x2, y2, x2+w2, y2+h2.

Union can be calculated as: ux1=min (x1, x2)=50, uy1=min (x1, x2)=50, Ux2=max (x1+w1, x2+w2)=800, uy2=max (y1+h1, y2+h2)=800.

Intersection can be calculated as: ux1=max (x1, x2)=400, uy1=max (y1, y2)=300, ux2=min (x1+w1, x2+w2)=450, uy2=min (y1+h1, y2+h2)=550.

Area of intersection of first and second scanned pages (intersection involve two pages or more)=width of intersection×height of intersection

width of intersection is calculated as abs(ux2−ux1)=(450−50)=50

height of intersection is calculated as abs(uy2−uy1)=(550−300)=150

$$Area of intersection = 50 \times 150 = 7 , 500$$

Similarly, for area of union of first and second scanned pages=width of union×height of union

$$width of union = abs ( ux 2 - ux 1 ) = ( 800 - 50 ) = 750$$

$$height of union = abs ( uy 2 - uy 1 ) = ( 800 - 50 ) = 750$$

$$Area of union = 750 \times 750 = 562 , 500$$

ux1, ux2, uy1, uy2 are calculated as shown above and also shown in FIG. 3E.

$$IOU = ( Area of intersection ) / ( Area of Union ) i . e . , ( ( 50 \times 150 ) / ( 750 \times 750 ) = 7500 / 562 , 500 = 0.0133$$

The IoU calculation as shown above is in pixels. But other formats and units can be used for IoU calculation and other coordinate as involved in the calculation.

In all the discussed implementations, it is considered that the user first places the front sides of multiple pages on the scanning platform and upon flipping, he then places back sides of these multiple pages near the same location on the scanning platform. But the user may sometimes wrongly place the pages on the platform or may not place the pages correctly, the disclosure can be implemented for such scenarios as well.

### Scenario 1:

It can be considered that the user wishes to scan a 3-page document, where page 1-3 has content and page 4 has no content. The user first places pages 1 and 3 on the platen and scans these pages. While flipping the pages, the user by mistake flips page 1 and places page 2 near where page 3 was placed. The disclosure considers all such scenarios/situations and still correctly identifies that scanned page 2 is back side of the scanned page 1. The intersection over union is calculated of scanned page 2 with scanned page 1 and page 3. If the IoU of the scanned page is 1 greater with page 3, then an additional check point can be considered where the total number of pages are considered. Based on that consideration, the scanned page 2 is considered as back side of the scanned page 1. This way, the disclosure identifies, and associates correct back side to the corresponding front side.

### Scenario 2:

It can be considered that user wishes to scan 4-page document. The user first places pages 1 and 3 on the platen and scans these pages. The user then flips the pages and places page 2 and 4 on the platen for scanning. While flipping the pages, page 2 got folded a little by mistake by the user. Thereafter, IoU is calculated as discussed above. IoU is calculated for scanned page 2 with scanned pages 1 and 3. While doing IoU calculation, the pre-defined threshold is relaxed a bit such that the overlap between the scanned pages 2 and 1 can be identified and the association can be done correctly.

For intersection calculation, the disclosure considers that both the (front and back) page scans overlap with each other. But there can be situations where the page size may be small such as receipts. The user may shift the pages when they are flipping them and as a result, there is a possibility that the content may not overlap with the previous scan. In such cases, the system can ask the user to manually select which page is the back side of the previous scan. Alternatively, the disclosure can deduce from other page scans (if two pages are scanned side by side) that there is an intersection of the 1st page front (page 1) and back (page 2), but not for the pages scanned in second scan session (page 3 and page 4). It can be considered that the second content (page 4) that is detected in the 2nd scan is the back side of page 3.

In some implementations, fall back to nearness of the page compared previous scan can be considered as an alternate approach to identify correct back side of a front side. For example, mostly, page 4 is placed somewhere near to the place where page 3 was placed. Fallback to nearness checks how near the pages were placed in the first scan session and second scan session.

The methods and systems can be incorporated in the form of an application program. The application program runs on a multi-function device for scanning multiple pages, the application program works in tandem with one or more components of the multi-function device. The application program receives scanned front sides of multiple pages, wherein the front sides of the multiple pages are scanned in a first scan session. The application program further receives scanned back sides of multiple pages, wherein the back sides of the multiple pages are scanned in a second scan session. Upon receiving the scanned front sides and scanned back sides, the application program associates the back side of a scanned page with the corresponding front side of that scanned page. The association is performed based on an overlap and non-overlap area of the multiple pages scanned in the first scan session and the second scan session. Based on the association, the application program arranges the scanned pages such that all scanned pages are in correct order in a scanned output.

In one example, the application program associates the back side of a scanned page with the corresponding front side of that scanned page based on intersection over union calculation. The application program determines an area of intersection of pages scanned in the first scan session and pages scanned in the second scan session. The application program further determines an area of union between pages scanned in the first scan session and pages scanned in the second scan session. The application program uses a pre-defined equation such as areas of intersection/area of union to find the scanned back side of a corresponding scanned front side. This way, the application program identifies scanned back sides of all corresponding front sides.

In some implementations, the application program determines association between pages scanned in the first session and second session, pages based on their placement locations from left to right and/or from top to bottom.

### Example Flowcharts

FIG. 6 is a flowchart showing a method 600 for scanning multiple pages and automatically sequencing of the scanned pages in a correct order. The method 600 can be implemented on a multi-function device, scanner or a mobile device. The multiple pages are single sided pages. These multiple pages may be a part of a single document or may be individual documents. The user places these multiple pages on a platen and initiates a scan action. At 602, multiple pages placed on the platen are received for scanning. The multiple pages are scanned and further cropped or segmented as individual pages. Then, these pages are arranged based on their placement location of these pages on the platen at 604. For example, a check is performed from left to right and then from top to bottom to determine the pages placed on the platen. For example, when a page placed on the left side of the platen is identified, then top to bottom is checked to identify its boundary and this way scanned page 1 is identified. Upon further checking by moving on the right side of platen, a blank space which is considered as no page. Moving further on the right side on the platen, when a page is identified then top to bottom is checked to identify its boundary and this way scanned page 2 is identified. Similarly, all pages placed on the platen are identified and arranged in a correct order. Before creating the final scanned document, it is checked if there are more pages to be scanned. If yes, blocks 602-604 are repeated. Repeat the process if there are more pages to be scanned. Finally, a scanned output is generated at 606. The scanned output can be one or more scanned documents with all scanned pages in a correct order.

The user indicates that it is single side scanning. It is determined that top left is page 1, top right is page 2, bottom left is page 3 and bottom right is page 4. It is considered that the user places the document from left to right and from top to bottom. In cases where some geographies may follow a different order for placing documents/pages on the platen, for example, they may place right to left and so on. The system can determine the page sequence accordingly.

There are scenarios when an overlap between two scanned pages is not identified. This indicates a back side of a corresponding front side is not detected due a to a number of reasons such as wrong page placement and so on. Then, a notification is shown to the user. In such cases, an input from the user can be taken. For example, a user interface is presented to the user to manually input which scanned page is a back side of a scanned front page and that page can be marked as page 2, for example. There can be scenarios where the user may place pages which do not overlap with previous positions. In such cases, the system may not be able to detect the back side of the front page. In such cases, the system may increase the area of the scanned page 1 and scanned page 2. Again, IOU is calculated and this time, intersection is detected, and the system may find back side of the front side. If the system is still not able to detect, then the system may seek input from the user. The system may present a user interface to the user with all scanned pages and asks the user to mark the back side of page 1. The system can automatically arrange the remaining scanned pages and result into a sequenced scanned document.

The system can be implemented in a similar fashion. The mobile device includes an image capturing module such as camera, an application running on the mobile device to determine which scanned page is back side of corresponding scanned front side. The mobile device requires a resolution such that the documents captured are clear in nature. For example, the mobile device may have 72 DPI for any digital document. But for any document with handwritten content, the mobile device may have 200 DPI. The user can further indicate size of pages such as C5, B5, A5 or the like.

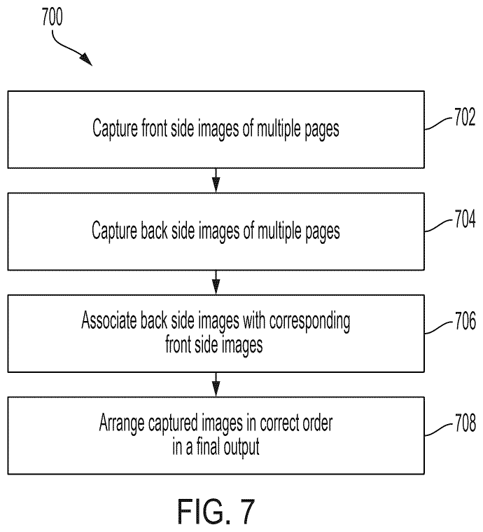

FIG. 7 is a flowchart showing a method for capturing multiple pages, specifically, using a mobile device. The method 700 begins when a user wishes to capture multiple pages. The user places the multiple pages on a platform for scanning, such as a table. The user then opens an image capturing application and provides an input such as click action to capture the pages. In a first session, an image of front side of each of the multiple pages placed on a platform is captured at 702. Then, the user again performs a click action to capture the multiple pages. In a second session, an image of back side of each of multiple pages placed on the platform is captured 704. Once captured, the front side images of the multiple pages and the back side images of the multiple pages are stored for further processing, retrieval and/or use. After capturing the front side images and back side images, processing of the captured images begins. For example, it is detected that there are multiple pages in the first session and the second session and those multiple pages are segregated from each other.

For each captured image, back side images are associated with the corresponding front side images, based on an overlap and non-overlap area of the multiple images captured in the first session and the second session at 706. For example, a back side image is identified and associated with a corresponding front side image, from the multiple images captured in the first session.

In one example, back side images are associated with the corresponding front side images based on intersection over union calculation.

The intersection over union calculation includes finding an area of intersection of the multiple pages captured in the first session and the second session. The intersection over union calculation finding an area of union of the multiple pages captured in the first session and the second session. This way, back sides images are associated with the corresponding front side images of the multiple pages.

Based on the association, the captured images are arranged such that all captured images are in correct order in a final output at 708. The captured images are arranged such that all captured back side images are correctly arranged with their corresponding captured front side images of the multiple pages.

The method 700 may include associating the back side images with the corresponding front side images based on their placement location from left to right and/or from top to bottom. Additionally, the method 700 may use a centre matching approach for associating the back side images with their respective front side images. The term “centre matching approach” is a known term in image processing that refers to a technique where the primary focus is on identifying and matching the central point (or “centre”) of an object or feature within an image, often used in template matching scenarios, where a smaller template image is compared against a larger image to find its location by aligning the center of the template with the corresponding point in the larger image, and then assessing the similarity between the surrounding pixels. The additional ways of associating the back side images with front side images may be performed in conjunction with intersection over union calculation or may be implemented independently.

The method 700 can be implemented or incorporated in the form of a mobile app or a web-based app. The app includes one or more modules to execute the functionalities of the method 700. The app can execute the functionalities as disclosed in other method flowcharts such as 400, 500, and 600.

The disclosure provides methods and systems for easy scanning of multiple pages such that the number of scans (and thereby, physical actions) are minimized. The methods and systems allow the user to scan multiple pages using any device such as a multi-function device, a scanner or even from a mobile device. For example, the user places two or more pages on a table (for photographing via phone/tablet) or platen (if there is space) and performs a batch scan/picture of front side. The methods and systems further order the pages in the correct sequence when the user flips all the pages. The disclosure can be useful for users who wish to scan multiple small-sized documents that need to be sequenced. The disclosure can be useful for scanning documents such as ID cards like covid cards with critical information on both sides as well as useful for scanning fragile documents that are unable to move through document handler due to age, mechanical stability, or tears. The methods and systems allow batch scanning of multiple pages. The methods and systems detect that there are multiple unique pages and crops each of the artifacts as a separate page.

The disclosure is proposed with an aim to reduce the number of scan operations by device or image capturing operations such as photo click operations that the user need to perform while scanning the multiple pages. The present disclosure further solves the problem of sequencing pages, specifically, when dual pages are scanned. For example, the disclosure provides a novel way of determining which page from scan session 2 is back side of the pages from the scan session 1.

Various examples of the pages can be bills, resumes, loan application forms or the like. In case the multiple pages are different documents, the documents can be of same size or different sizes.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system and/or the apparatus and/or any electronic device (not shown).

The above description does not provide specific details of the manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems. This document may use the term “app” or “computer program product” to refer to a processor-readable medium containing such instructions.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, storing, retrieving, scanning, arranging, sequencing, determining, associating, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for scanning multiple pages, the method comprising, by a multi-function device:
receiving multiple pages to be scanned on a platen of the multi-function device;
initiating a first scan session to scan the front side of each of the multiple pages placed on the platen;
initiating a second scan session to scan a back side of each of the multiple pages placed on the platen;
for each of the scanned pages, associating the back side of the scanned page from the second session with the corresponding front side of that scanned page from the first session, based on an overlap area and a non-overlap area of the multiple pages scanned in the first scan session and the second scan session; and
based on the association, arranging the scanned pages such that all scanned pages are in correct order in a scanned output.

2. The method of claim 1, further comprising storing the scanned front sides from the first scan session, the scanned back sides from the second scan session, or both scanned sides of each of the multiple pages in a computer-readable memory.

3. The method of claim 1, wherein associating the back side of the scanned page from the second scan session with the corresponding front side of that scanned page from the first scan session further comprises using an intersection over union (IoU) calculation.

4. The method of claim 3, wherein the intersection over union (IoU) calculation comprises finding an area of intersection between the multiple pages scanned in the first scan session and the multiple pages scanned in the second scan session.

5. The method of claim 3, wherein the intersection over union (IoU) calculation comprises finding an area of union between the multiple pages scanned in the first scan session and the second scan session.

6. The method of claim 1, where the multiple pages are a part of a single document.

7. The method of claim 1, wherein arranging the scanned pages comprises arranging the scanned pages such that all scanned back sides of the multiple pages are correctly arranged with their corresponding scanned front sides of the multiple pages.

8. The method of claim 1, further comprising, wherein associating the back side of the scanned page from the second scan session with the corresponding front side of that scanned page from the first scan session is further based on their placement location from left to right and/or from top to bottom.

9. The method of claim 1, further comprising using a centre matching approach when the scanned back sides with their respective scanned front sides.

10. The method of claim 1, further comprising using a fall to nearness approach when associating the scanned back sides with their respective scanned front sides.

11. The method of claim 1, further comprising, providing an option to a user to input a back side of a corresponding front side for confirmation via a user interface.

12. A multi-function device for scanning multiple pages, the multi-function device comprising:
a platen for:
receiving a front side of each of the multiple pages to be scanned, and
receiving a back side of each of the multiple pages to be scanned;
a scanner for:
initiating a first scan session to scan the front side of each of the multiple pages placed on the platen, and
initiating a second scan session to scan the back side of each of the multiple pages placed on the platen; and
a controller comprising a processor and computer-readable programming instructions that are configured to cause the processor to:
for each scanned page, associate the back side of the scanned page with the corresponding front side of that scanned page based on an overlap area and a non-overlap area between the pages scanned in the first scan session and the second scan session; and
based on the association, arranging the scanned pages such that all scanned pages are in correct order in a scanned output.

13. The multi-function device of claim 12, further comprising a memory for:
storing the scanned front sides of the multiple pages, and
storing the scanned back sides of the multiple pages.

14. The multi-function device of claim 12, wherein the controller further comprises instructions to determine the overlap area by finding an area of intersection between the multiple pages scanned in the first scan session and the second scan session.

15. The multi-function device of claim 12, wherein the controller further comprises instructions to determine the non-overlap area by finding an area of union between the multiple pages scanned in the first scan session and the second scan session.

16. A method for scanning multiple pages, the method comprising:
by a multi-function device:
receiving multiple pages to be scanned on a platen of the multi-function device, and
scanning the multiple pages placed on the platen; and
by a controller comprising a processor and computer-readable programming instructions:
identifying a correct order of the multiple pages for association, based on their placement location on the platen, and
based on the identification, arranging the scanned pages such that all scanned pages are in correct order in a scanned output.

17. The method of claim 16, wherein the instructions for identifying the correct order comprise instructions to do so based on placement of the multiple pages from left to right and/or from top to bottom.

18. The method of claim 16, further comprising instructions for associating scanned back sides of the multiple pages with corresponding scanned front sides of the multiple pages based on their placement location.

19. A computer program product on a multi-function device for scanning multiple pages, wherein the application program works in tandem with one or more components of the multi-function device and is configured to:
in response to the multi-function device:
receiving scanned front sides of multiple pages, wherein the front sides of the multiple pages are scanned in a first scan session, and
receiving scanned back sides of the multiple pages, wherein the back sides of the multiple pages are scanned in a second scan session:
associate the back side of a scanned page with the corresponding front side of that scanned page, based on an overlap area and a non-overlap area of the multiple pages scanned in the first scan session and the second scan session; and
based on the association, arrange the scanned pages such that all scanned pages are in correct order in a scanned output.

20. The computer program product of claim 19, wherein the instructions to associate the back side of a scanned page with the corresponding front side of that scanned page comprise instructions to do so based on an intersection over union calculation that comprises:
determining an area of intersection of pages scanned in the first scan session and pages scanned in the second scan session; and
determining an area of union between pages scanned in the first scan session and pages scanned in the second scan session.
